(19) United States
(12) Patent Application Publication
(10) Pub. No.: US 2022/0148316 A1
(43) Pub. Date: May 12, 2022

(54) METHOD AND DEVICE FOR DETERMINING ROAD OPERATION CONDITION, AND STORAGE MEDIUM

(71) Applicant: SHANGHAI SENSETIME INTELLIGENT TECHNOLOGY CO., LTD., Shanghai (CN)

(72) Inventors: Yuheng KAN, Shanghai (CN); Zian MA, Shanghai (CN); Shuai BAI, Shanghai (CN); Chengkai ZHU, Shanghai (CN); Wei WU, Shanghai (CN)

(73) Assignee: SHANGHAI SENSETIME INTELLIGENT TECHNOLOGY CO., LTD., Shanghai (CN)

(21) Appl. No.: 17/648,931

(22) Filed: Jan. 25, 2022

Related U.S. Application Data
(63) Continuation of application No. PCT/CN2021/083433, filed on Mar. 26, 2021.

(30) Foreign Application Priority Data
Sep. 14, 2020 (CN) 202010963859.8

(51) Int. Cl. G06V 20/54; G06V 10/82; G06V 10/26; G08G 1/01; G08G 1/04

(52) U.S. Cl. CPC G06V 20/54; G06V 10/82; G06V 2201/08; G08G 1/0133; G08G 1/04; G06V 10/26

(57) ABSTRACT

A method for determining road operation condition includes: acquiring an image of a road to be monitored; acquiring the number of vehicles on the road to be monitored, and dividing the road to be monitored into an upstream road and a downstream road based on the image and the number of vehicles on the road to be monitored; acquiring the number of vehicles on the upstream road and the number of vehicles on the downstream road, and determining a target domain value based on the number of vehicles on the road to be monitored, the number of vehicles on the upstream road, the number of vehicles on the downstream road, and a traffic wave of the road to be monitored; and determining that congestion occurs on the road to be monitored if the number of vehicles on the road to be monitored is greater than the target domain value.

### CROSS-REFERENCE TO RELATED APPLICATIONS

This is a continuation of International Patent Application No. PCT/CN2021/083433 filed on Mar. 26, 2021, which claims priority to Chinese Patent Application No. 202010963859.8 filed on Sep. 14, 2020. The disclosures of the above-referenced applications are hereby incorporated by reference in their entirety.

### BACKGROUND

With the rapid growth of demand for motor vehicle traffic, serious traffic congestion occurs in urban expressways and intercity highways. In order to facilitate the traffic management department to perceive the operation status of a road network in real time and in all directions, and to make management and control predictions, it is particularly important for the traffic management department to accurately and timely identify congestion.

### SUMMARY

The present disclosure relates to the field of computer vision technologies, and relates to, but is not limited to, a method and an apparatus for determining road operation condition, a device, and a storage medium. The technical solutions in the embodiments of this application are implemented as follows.

The embodiments of this application provide a method for determining road operation condition. The method includes the following operations.

An image of a road to be monitored is acquired, where the image is obtained by photographing the road to be monitored. The number of vehicles on the road to be monitored is acquired, and the road to be monitored is divided into an upstream road and a downstream road based on the image and the number of vehicles on the road to be monitored. The number of vehicles on the upstream road and the number of vehicles on the downstream road are acquired, and a target domain value is determined based on the number of vehicles on the road to be monitored, the number of vehicles on the upstream road, the number of vehicles on the downstream road, and a traffic wave of the road to be monitored. In a case where the number of vehicles on the road to be monitored is greater than the target domain value, it is determined that congestion occurs on the road to be monitored.

The embodiments of this application provide an apparatus for determining road operation condition. The apparatus includes: an acquisition unit, a division unit, a first determination unit, and a second determination unit.

The acquisition unit is configured to acquire an image of a road to be monitored, where the image is obtained by photographing the road to be monitored. The division unit is configured to acquire the number of vehicles on the road to be monitored, and divide the road to be monitored into an upstream road and a downstream road based on the image of the road to be monitored and the number of vehicles on the road to be monitored. The first determination unit is configured to acquire the number of vehicles on the upstream road and the number of vehicles on the downstream road, and determine a target domain value based on the number of vehicles on the road to be monitored, the number of vehicles on the upstream road, the number of vehicles on the downstream road, and a traffic wave of the road to be monitored. The second determination unit is configured to determine that congestion occurs on the road to be monitored in a case where the number of vehicles on the road to be monitored is greater than the target domain value.

The embodiments of this application provide a device for determining road operation condition. The device includes at least a memory, a communication bus, and a processor.

The memory is configured to store a program for determining road operation condition. The communication bus is configured to implement connection communication between the processor and the memory. The processor is configured to execute the program for determining road operation condition stored in the memory, so as to implement the steps of the method for determining road operation condition as described above.

The embodiments of this application provide a storage medium, having a computer program stored thereon, where the computer program, when executed by a processor, implements the steps of the method for determining road operation condition as described above.

The embodiments of this application provide a computer program, including a computer-readable code, where when the computer-readable code runs in a device for determining road operation condition, a processor in the device for determining road operation condition executes the computer program to implement the steps of the method for determining road operation condition as described above.

### BRIEF DESCRIPTION OF THE DRAWINGS

FIG. 1 is a schematic structural diagram of a system according to an embodiment of this application.

FIG. 2 is a schematic flowchart of a method for determining road operation condition according to an embodiment of this application.

FIG. 3 is another schematic flowchart of a method for determining road operation condition according to an embodiment of this application.

FIG. 4 is a schematic diagram of a division model for dividing a road to be monitored into roads in different directions in a method for determining road operation condition according to an embodiment of this application.

FIG. 5 is a schematic diagram of two adjacent cells according to an embodiment of this application.

FIG. 6A is a first schematic diagram of dividing a road to be monitored in a method for determining road operation condition according to an embodiment of this application.

FIG. 6B a second schematic diagram of dividing a road to be monitored in a method for determining road operation condition according to an embodiment of this application.

FIG. 6C is a third schematic diagram of dividing a road to be monitored in a method for determining road operation condition according to an embodiment of this application.

FIG. 6D is a fourth schematic diagram of dividing a road to be monitored in a method for determining road operation condition according to an embodiment of this application.

FIG. 7A is a first schematic diagram of congestion formation on a road to be monitored in a method for determining road operation condition according to an embodiment of this application.

FIG. 7B is a second schematic diagram of congestion formation on a road to be monitored in a method for determining road operation condition according to an embodiment of this application.

FIG. 8 is still another schematic flowchart of a method for determining road operation condition according to an embodiment of this application.

FIG. 9 is a schematic diagram of congestion of a road to be monitored propagating upstream in a method for determining road operation condition according to an embodiment of this application.

FIG. 10A is a first schematic diagram of a road to be monitored before and after rotation of a camera according to an embodiment of this application.

FIG. 10B is a second schematic diagram of a road to be monitored before and after rotation of a camera according to an embodiment of this application.

FIG. 10C is a third schematic diagram of a road to be monitored before and after rotation of a camera according to an embodiment of this application.

FIG. 10D is a fourth schematic diagram of a road to be monitored before and after rotation of a camera according to an embodiment of this application.

FIG. 11 is yet another schematic flowchart of a method for determining road operation condition according to an embodiment of this application.

FIG. 12 is a schematic structural diagram of an apparatus for determining road operation condition according to an embodiment of this application.

FIG. 13 is a schematic structural diagram of a device for determining road operation condition according to an embodiment of this application.

### DETAILED DESCRIPTION

To make the objectives, technical solutions, and advantages of this application clearer, the following describes this application in further detail with reference to the accompanying drawings. The described embodiments should not be considered as a limitation to this application. All other embodiments obtained by a person of ordinary skill in the art without creative efforts shall fall within the protection scope of this application.

In the following description, the term “some embodiments” describes subsets of all possible embodiments, but it may be understood that “some embodiments” may be the same subset or different subsets of all the possible embodiments, and can be combined with each other without conflict.

In some implementations, road congestion is generally identified using conventional detectors or based on video detection. In the solution of identifying road congestion using conventional detectors, the speed of vehicles running on a road is mostly determined through GPS data returned by vehicles or by detectors such as radar. In a solution of identifying road congestion based on video detection, an observation area is manually drawn to determine the speed of vehicles in the observation area so as to predict the congestion status of the observation area, or a deep neural network is employed to directly predict the congestion status of the observation area. However, since the solutions of determining road congestion can be are affected by different factors, there is a problem that determination of the road congestion is inaccurate.

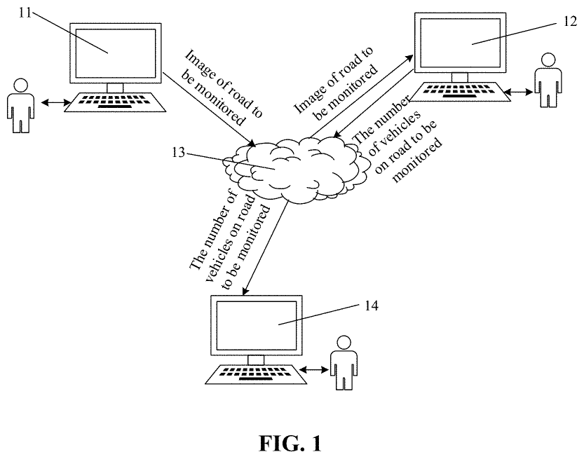

FIG. 1 is a schematic diagram of a system according to an embodiment of this application. Referring to FIG. 1, the system includes: an image acquisition terminal 11, a vehicle information acquisition terminal 12, a network 13, and an information determination terminal 14. In order to support an exemplary application, the image acquisition terminal 11, the vehicle information acquisition terminal 12, and the information determination terminal 14 establish a communication connection through the network 13. The image acquisition terminal 11 monitors a road to be monitored, and acquires an image of the road to be monitored in real time, and then reports the acquired image of the road to be monitored to the vehicle information acquisition terminal 12 and the information determination terminal 14 through the network 13. In response to receiving the image of the road to be monitored, the vehicle information acquisition terminal 12 analyzes the image of the road to be monitored to obtain the number of vehicles on the road to be monitored, and then reports the number of vehicles on the road to be monitored to the information determination terminal 14 through the network 13. The information determination terminal 14 divides the road to be monitored into an upstream road and a downstream road based on the image of the road to be monitored and the number of vehicles on the road to be monitored, then acquires the number of vehicles on the upstream road and the number of vehicles on the downstream road, and determines a target domain value based on the number of vehicles on the road to be monitored, the number of vehicles on the upstream road, the number of vehicles on the downstream road, and a traffic wave of the road to be monitored. Finally, in a case where the number of vehicles on the road to be monitored is greater than the target domain value, the information determination terminal 14 determines that congestion occurs on the road to be monitored.

As an example, the image acquisition terminal 11 may include an image acquisition device. The vehicle information acquisition terminal 12 may include a server or a device with the capability to process image data. The network 13 may adopt a wired connection or wireless connection mode. The information determination terminal 14 may include a visual processing device or a remote server with visual information processing capability. When the information determination terminal 14 is a visual processing device, the image acquisition terminal 11 may be in communication connection with the visual processing device through wired connection, for example, performing data communication through a bus. When the information determination terminal 14 is a remote server, the image acquisition terminal 11 may perform data interaction with the remote server through a wireless network. Certainly, the vehicle information acquisition terminal 12 may also perform data interaction with the image acquisition terminal 11 through the wireless network or a wired network.

Alternatively, in some scenes, the image acquisition terminal 11 may be a processing device with an image acquisition module, and is specifically implemented as a host with camera(s). In this case, the method for determining road operation condition in the embodiments of this disclosure can be executed by the image acquisition terminal 11, and the above system may not include the vehicle information acquisition terminal 12, the network 13, and the information determination terminal 14.

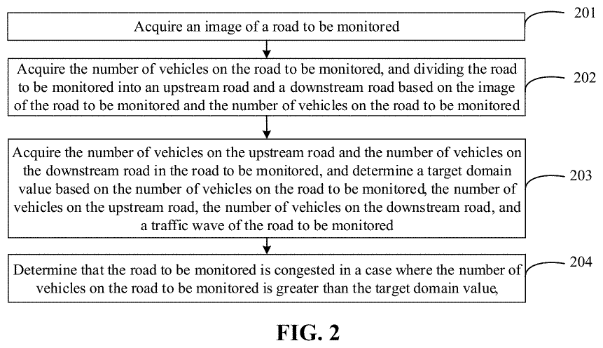

The embodiments of this application provide a method for determining road operation condition. The method can be applied to a device for determining road operation condition. Referring to FIG. 2, the method includes the following operations.

At operation 201, an image of a road to be monitored is acquired. The image is obtained by photographing the road to be monitored.

In some embodiments of this application, the image of the road to be monitored may be obtained by capturing exemplary pictures of the road to be monitored. In some embodiments of this application, a video of the road to be monitored is captured in real time, and a plurality of image frames are acquired from the video of the road to be monitored to obtain the image of the road to be monitored.

At operation 202, the number of vehicles on the road to be monitored is acquired, and the road to be monitored is divided into an upstream road and a downstream road based on the image of the road to be monitored and the number of vehicles on the road to be monitored.

The image of the road to be monitored is analyzed to determine traveling directions of the vehicles on the road to be monitored, and then the road to be monitored can be divided into the upstream road and the downstream road according to the traveling directions, the image of the road to be monitored, and the number of vehicles on the road to be monitored. It is to be noted that the road to be monitored in the same direction may be divided into the upstream road and the downstream road, and the number of vehicles on the road to be monitored within a period of time may be acquired.

At operation 203, the number of vehicles on the upstream road and the number of vehicles on the downstream road in the road to be monitored are acquired, and a target domain value is determined based on the number of vehicles on the road to be monitored, the number of vehicles on the upstream road, the number of vehicles on the downstream road, and a traffic wave of the road to be monitored.

Herein, the number of vehicles on the upstream road in the road to be monitored within the period of time and the number of vehicles on the downstream road in the road to be monitored within the period of time may be acquired. The traffic wave of the road to be monitored may be a traffic wave of the road to be monitored at a suspected congestion moment. After the corresponding number of vehicles are acquired, the suspected congestion moment and a suspected congestion number may be determined first according to the number of vehicles on the road to be monitored, and then according to the number of vehicles on the upstream road in the road to be monitored, the number of vehicles on the downstream road in the road to be monitored, and the suspected congestion moment, when it is determined that a congested traffic wave exists in the traffic wave of the road to be monitored at the suspected congestion moment, a target threshold value is set as the suspected congestion number. It is to be noted that the suspected congestion number is the number of vehicles on the road to be monitored at the suspected congestion moment.

At operation 204, in a case where the number of vehicles on the road to be monitored is greater than the target domain value, it is determined that congestion occurs on the road to be monitored.

When the number of vehicles on the road to be monitored is greater than the target threshold value, it may be considered that the number of vehicles on the road to be monitored at this moment is relatively large, and congestion occurs on the road to be monitored at this moment. In some embodiments of this application, in order to avoid temporary congestion caused by a certain emergency, such as a sudden U-turn of a vehicle, when a duration during which the number of vehicles on the road to be monitored is greater than the target threshold value exceeds a preset time threshold value, it can be determined that congestion occurs on the road to be monitored. In this case, information of the congested road can be reported to a traffic management department.

According to the method for determining road operation condition provided by the embodiments of this application, an image of a road to be monitored and the number of vehicles on the road to be monitored are acquired, where the image is obtained by photographing the road to be monitored; the road to be monitored is divided into an upstream road and a downstream road based on the image of the road to be monitored and the number of vehicles on the road to be monitored; the number of vehicles on the upstream road and the number of vehicles on the downstream road in the road to be monitored are acquired, and a target domain value is determined based on the number of vehicles on the road to be monitored, the number of vehicles on the upstream road, the number of vehicles on the downstream road, and a traffic wave of the road to be monitored; and in a case where the number of vehicles on the road to be monitored is greater than the target domain value, it is determined that congestion occurs on the road to be monitored. In this way, whether congestion occurs on the road to be monitored can be determined directly based on the target threshold value determined according to the image of the road to be monitored and the number of vehicles on the road, without manually setting a monitoring area or determining the speeds of the vehicles. The solutions for determining road congestion in related technologies have the problem of inaccurate determination of road congestion. This application improves the accuracy of determining road congestion.

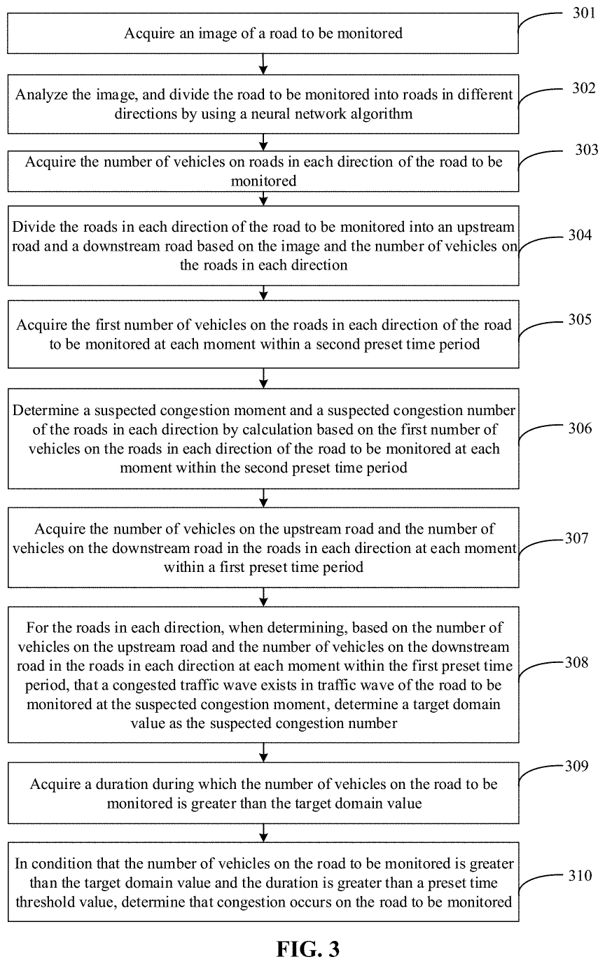

Based on the foregoing embodiments, the embodiments of this application provide a method for determining road operation condition. Referring to FIG. 3, the method includes the following operations.

At operation 301, a device for determining road operation condition acquires an image of a road to be monitored. The image of the road to be monitored is obtained by photographing the road to be monitored.

It is to be noted that the image of the road to be monitored may be obtained by acquiring images, at intervals of a certain number of frames, from a video of the road to be monitored that is obtained by real-time photographing. In some embodiments of this application, the road to be monitored may be a section of road required to be monitored regardless of traveling directions of vehicles, that is, the road to be monitored includes roads having different traveling directions. Alternatively, the road to be monitored may also be a section of road to be monitored that is separated according to the traveling directions of the vehicles, that is, the road to be monitored includes roads having a fixed traveling direction. If the road to be monitored only includes roads having a fixed traveling direction, there is no need to perform the step of dividing the road to be monitored into roads in different directions during actual implementation.

At operation 302, the device for determining road operation condition analyzes the image of the road to be monitored by using a neural network algorithm, and divides the road to be monitored into roads in different directions.

Dividing the road to be monitored into the roads in different directions may be realized by analyzing the image by using a neural network algorithm. In some embodiments of this application, a division model shown in FIG. 4 may be employed to analyze the image using a residual neural network (ResNet) algorithm in the neural network algorithm and a Deeplab v3 neural network algorithm, so as to determine the roads in different directions in the road to be monitored. It is to be noted that the roads in different directions in the road to be monitored are divided according to the traveling directions of the vehicles. In some embodiments of this application, the road to be monitored may be divided into roads in two directions, i.e., roads in a first direction and roads in a second direction.

At operation 303, the device for determining road operation condition respectively acquires the number of vehicles on roads in each direction of the road to be monitored.

At operation 304, the device for determining road operation condition respectively divides the roads in each direction of the road to be monitored into an upstream road and a downstream road based on the image of the road to be monitored and the number of vehicles on the roads in each direction.

In practical applications, along the traveling directions of the vehicles, the roads in each direction of the road to be monitored may be divided into two roads, i.e., the upstream road and the downstream road, according to the number of vehicles on the road to be monitored. If the road to be monitored only includes roads in one direction, the road to be monitored may be directly divided into the upstream road and the downstream road along the traveling directions of the vehicles, and there is no need to divide the roads in each direction separately.

It is to be noted that, the operation 304 that the device for determining road operation condition respectively divides the roads in each direction of the road to be monitored into an upstream road and a downstream road based on the image of the road to be monitored and the number of vehicles on the roads in each direction may be implemented in the following manner.

At operation 304a, the device for determining road operation condition respectively discretizes the roads in each direction into J parts. J is a positive integer greater than 1, and the distances of road sections corresponding to each of the parts are equal to each other.

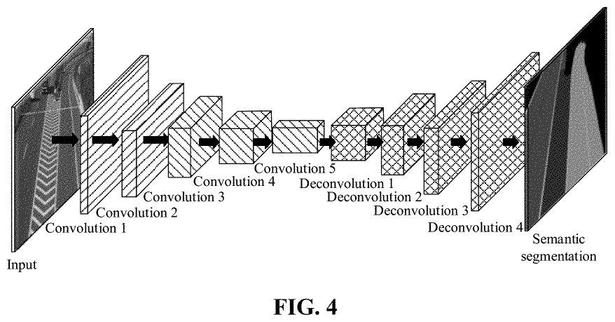

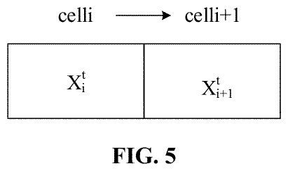

In practical applications, the road to be monitored may be spatially discretized into J cells with the equal distance by using a Cell Transmission Model (CTM), and time can be evenly divided into T time periods equal to the number of the cells. At a certain moment, the traffic state inside any one cell is considered to be homogeneous, the traffic state between adjacent cells can be used to simulate traffic shock waves, queue formation and queue dissipation. FIG. 5 is a schematic diagram of two adjacent cells, where xᵢ^{t} represents the number of vehicles on a road section of a road corresponding to cellᵢ, and xᵢ₊₁^{t} represents the number of vehicles on a road section of a road corresponding to cellᵢ₊₁. It is to be noted that according to multiple cells, it is possible to only confirm boundary lines of traffic-flow waves of the roads in each direction in a photographing scene corresponding to a dome camera or a gun camera, and divide the roads in each direction into the upstream road and the downstream road. Moreover, it may be understood that each cell may be considered to be a traffic-flow wave.

At operation 304b, the device for determining road operation condition analyzes the image of the road to be monitored and the number of vehicles on the roads in each direction, and respectively determines the number of vehicles on each of the J parts of the roads in each direction within a first preset time period.

In the embodiments of this application, the determination of the number of vehicles includes two parts: self-correction model training and deep convolutional network prediction. The self-correction model training is divided into two stages. At the first stage, a fixed Gaussian density map label is used to supervise training of a depth counting network. The training process includes: inputting an image, obtaining a density map through feedforward network, calculating the Euclidean distance between the density map and the label as a loss function, and updating parameters of the network by back-gradient propagation. At the second stage, the density map label is corrected in combination with prediction of the model, and the loss function corresponding to the model is adopted. For the deep convolutional network prediction, after the image is inputted, a density map reflecting positions of the vehicle is output, and the sum of all pixel values in the density map is taken as the number of vehicles included in the images. The first preset time period may be a preset time period. In some embodiments of this application, the value of the first preset time period may be in a range from 120 to 300 seconds.

At operation 304c, the device for determining road operation condition performs calculation processing on the number of vehicles on each part of the roads in each direction within the first preset time period, and divides the roads in each direction into the upstream road and the downstream road based on a calculation result.

The device for determining road operation condition may determine a cut point according to the number of vehicles on each part of the roads in each direction within the first preset time period, and then divides the roads in each direction of the road to be monitored into the upstream road and the downstream road according to the cut point.

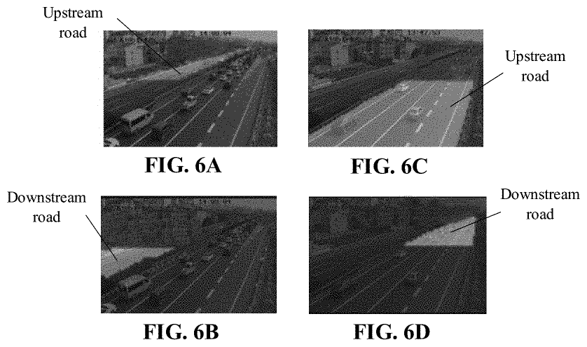

In some embodiments of this application, FIG. 6A to FIG. 6D exemplarily illustrate areas, in the road to be monitored, corresponding to the upstream road and the downstream road in the roads in each direction of the road to be monitored.

At operation 305, the device for determining road operation condition acquires the first number of vehicles on the roads in each direction of the road to be monitored at each moment within a second preset time period

At operation 306, the device for determining road operation condition determines a suspected congestion moment and a suspected congestion number for the roads in each direction by calculation based on the first number of vehicles on the roads in each direction of the road to be monitored at each moment within the second preset time period.

In the embodiments of this application, the second number of vehicles on the roads in each direction after a preset interval time from each moment within the second preset time period may be acquired, and the third number of vehicles on the roads in each direction before a preset interval time from each moment within the second preset time period may be acquired. Subsequently, the first number is compared with the second number and the third number to determine the suspected congestion moment and the suspected congestion number.

The operation 306 that the device for determining road operation condition determines a suspected congestion moment and a suspected congestion number for the roads in each direction by calculation based on the first number of vehicles on the roads in each direction of the road to be monitored at each moment within the second preset time period can be implemented in the following manner.

At operation 306a, the device for determining road operation condition acquires the second number of vehicles on the roads in each direction after a preset interval time from each moment within the second preset time period.

At operation 306b, the device for determining road operation condition acquires the third number of vehicles on the roads in each direction before the preset interval time from each moment within the second preset time period.

At operation 306c, for the roads in each direction, the device for determining road operation condition determines a moment at which the first number is less than the second number and the first number is greater than the third number as the suspected congestion moment, and determines the number of vehicles at the suspected congestion moment as the suspected congestion number.

The suspected congestion moment may be determined by comparing the first number with the second number and the third number. In a feasible implementation for the roads to be monitored, the suspected congestion moment may be determined using the following mathematical expressions (1) and (2). If the first number for the roads in each direction of the road to be monitored at a certain moment within the second preset time period is greater than the third number, the moment at which the first number is less than the second number is the suspected congestion moment.

$$\begin{matrix}{\sum }_{i = 1}^{2} {x}_{i}^{t} - {\sum }_{i = 1}^{2} {x}_{i}^{t - Δ t} > 0 & ( 1 ) \\ {\sum }_{i = 1}^{2} {x}_{i}^{t} - {\sum }_{i = 1}^{2} {x}_{i}^{t + Δ t} < 0 & ( 2 )\end{matrix}$$

where xᵢ^{t-Δt} represents the number of vehicles on a road section of a road corresponding to cell xᵢ^{t-Δt} at moment t−Δt, and xᵢ^{t+Δt} represents the number of vehicles on a road section of a road corresponding to cellᵢ at moment t+Δt. It is to be noted that the first number, the second number, and the third number refer to calculation of the sum of the number of vehicles on the upstream road and the number of vehicles on the downstream road in the road to be monitored.

It is to be noted that the second preset time period may be a value set after smoothing processing, and may be smoothed using historical numerical values of the vehicles on the road to be monitored at the past T moments. Differences between the numbers of vehicles at two moments before and after occurrence of congestion on the road are compared. If the value of T is too large, the process of sudden increase in the number of vehicles when congestion occurs is weakened. If the value of T is too small, the actual number of vehicles on the road fluctuates too much, making it difficult to analyze the actual trend of traffic-flow change. In some embodiments of this application, the value of the second preset time period may be in a range from 120 to 300 seconds, and the value of Δt may be from 2 to 5 minutes.

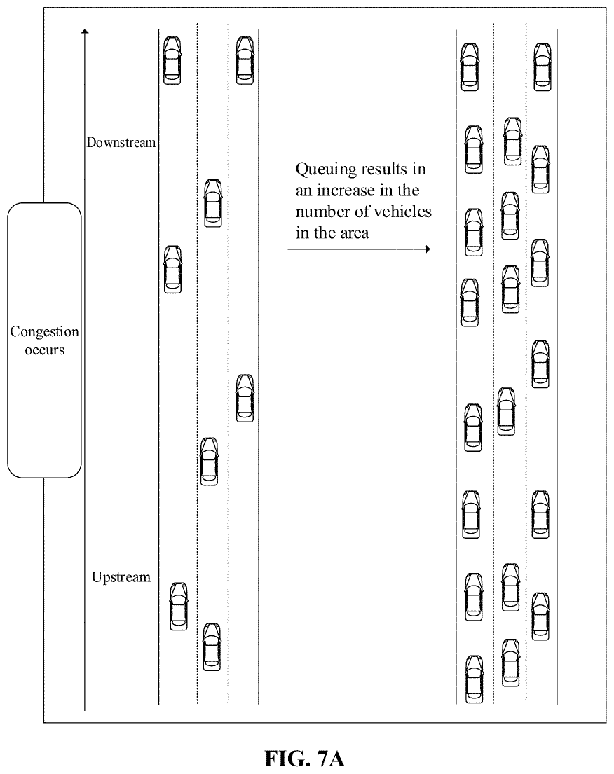

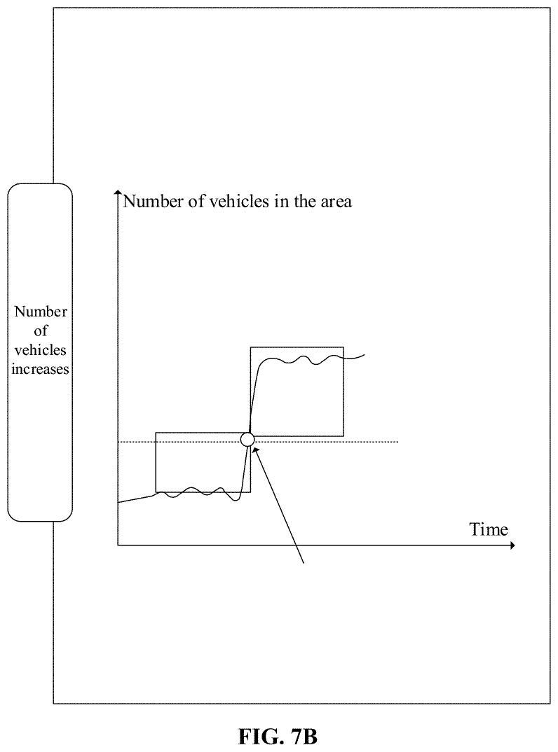

As shown in FIG. 7A, when congestion occurs on a road, the traffic-flow density increases, and the number of vehicles on the road before the congestion apparently increases due to the queue formed by the congestion. As shown in FIG. 7B, correspondingly, the number of vehicles also increases sharply over time when congestion occurs.

At operation 307, the device for determining road operation condition acquires the number of vehicles on the upstream road and the number of vehicles on the downstream road in the roads in each direction at each moment within the first preset time period.

At operation 308, for the roads in each direction, when determining, based on the number of vehicles on the upstream road and the number of vehicles on the downstream road in the roads in each direction at each moment within the first preset time period, that a congested traffic wave exists in the traffic wave of the road to be monitored at the suspected congestion moment, the device for determining road operation condition determines that the target domain value is the suspected congestion number.

The device for determining road operation condition may calculate the time during which the vehicles travel from the upstream road to the downstream road, and calculate a first growth rate of the upstream road in the roads in each direction of the road to be monitored at the suspected congestion moment, and a second growth rate of the downstream road in the roads in each direction after the operation time from the suspected congestion moment. A numerical value to be determined is obtained by calculation based on the first growth rate and the second growth rate, and a target threshold value is determined according to the relationship between the numerical value to be determined and the preset threshold value.

It is to be noted that the operation 308, i.e., for the roads in each direction, when determining, based on the number of vehicles on the upstream road and the number of vehicles on the downstream road in the roads in each direction at each moment within the first preset time period, that a congested traffic wave exists in the traffic wave of the road to be monitored at the suspected congestion moment, determining the target domain value as the suspected congestion number, may be implemented in the following manner.

At operation 308a, the device for determining road operation condition calculates operation time of the roads in each direction based on the number of vehicles on the upstream road and the number of vehicles on the downstream road in the roads in each direction at each moment within the first preset time period. The operation time is the time when the vehicles travel from the upstream road to the downstream road.

It is to be noted that the operation time may be calculated by using formula

$$τ = arg min {\sum }_{t = 0}^{T 1} ( {x}_{1 , k}^{t} - {x}_{k + 1 , J}^{t + Δ t} ) ,$$

where τ represents the operation time, x_{1,k}^{t} represents the number of vehicles on the upstream road at moment t, X_{k+1,J}^{t+Δt} represents the number of vehicles on the downstream road at moment t+Δt, and Δt is an unknown number. In some embodiments of this application, the value of τ may be the value of Δt corresponding to the minimum value of

$${\sum }_{t = 0}^{T 1} ( {x}_{1 , k}^{t} - {x}_{k + 1 , J}^{t + Δ t} ) .$$

At operation 308b, the device for determining road operation condition calculates a first growth rate for the upstream road in the roads in each direction of the road to be monitored at the suspected congestion moment, and a second growth rate for the downstream road in the roads in each direction after the operation time from the suspected congestion moment.

The first growth rate may be obtained by calculation based on the number of vehicles on the upstream road in the roads in each direction of the road to be monitored at the suspected congestion moment and the average number of vehicles on the upstream road over a period of time. In some embodiments of this application, the second growth rate may be obtained by calculation based on the number of vehicles on the downstream road in the roads in each direction of the road to be monitored at the suspected congestion moment and the average number of vehicles on the downstream road.

At operation 308c, for the roads in each direction, the device for determining road operation condition calculates a to-be-determined numerical value based on the first growth rate and the second growth rate

A first difference between the first growth rate and the second growth rate may be calculated, and a second difference between the number of vehicles on the roads in each direction at the suspected congestion moment and the number of vehicles on the roads in each direction at the previous moment of the suspected congestion moment may be calculated. Subsequently, the to-be determined numerical value is calculated based on the first difference and the second difference.

At operation 308d, for the roads in each direction, in a case that the value of the numerical value to be determined is greater than a preset threshold value, the device for determining road operation condition determines that a congested traffic wave exists in the traffic wave of the road to be monitored at the suspected congestion moment, and determines the target threshold value as the suspected congestion number.

At operation 309, the device for determining road operation condition acquires a duration during which the number of vehicles on the road to be monitored is greater than the target domain value.

At operation 310, the device for determining road operation condition determines that congestion occurs on the road to be monitored, in a case where the number of vehicles on the road to be monitored is greater than the target domain value and the duration is greater than a preset time threshold value.

It is to be noted that the methods for acquiring the number of vehicles on the road to be monitored in this embodiment may all use the method for obtaining the number of vehicles shown in the operation 304b. For descriptions of operations and contents in this embodiment identical to those in other embodiments, reference may be made to the descriptions in other embodiments.

According to the method for determining road operation condition provided by the embodiments of this application, an image of a road to be monitored and the number of vehicles on the road to be monitored are acquired, where the image is obtained by photographing the road to be monitored; the road to be monitored is divided into an upstream road and a downstream road based on the image of the road to be monitored and the number of vehicles on the road to be monitored; the number of vehicles on the upstream road and the number of vehicles on the downstream road in the road to be monitored are acquired, and a target domain value is determined based on the number of vehicles on the road to be monitored, the number of vehicles on the upstream road, the number of vehicles on the downstream road, and a traffic wave of the road to be monitored; and in a case where the number of vehicles on the road to be monitored is greater than the target domain value, it is determined that congestion occurs on the road to be monitored. In this way, whether congestion occurs on the roads to be monitored can be determined directly based on the target threshold value determined according to the images of the roads to be monitored and the number of vehicles on the road, without manually setting a monitoring area or determining the speed of the vehicles. The solutions for determining road congestion in related technologies have the problem of inaccurate determination of road congestion, while this application improves the accuracy of determining road congestion.

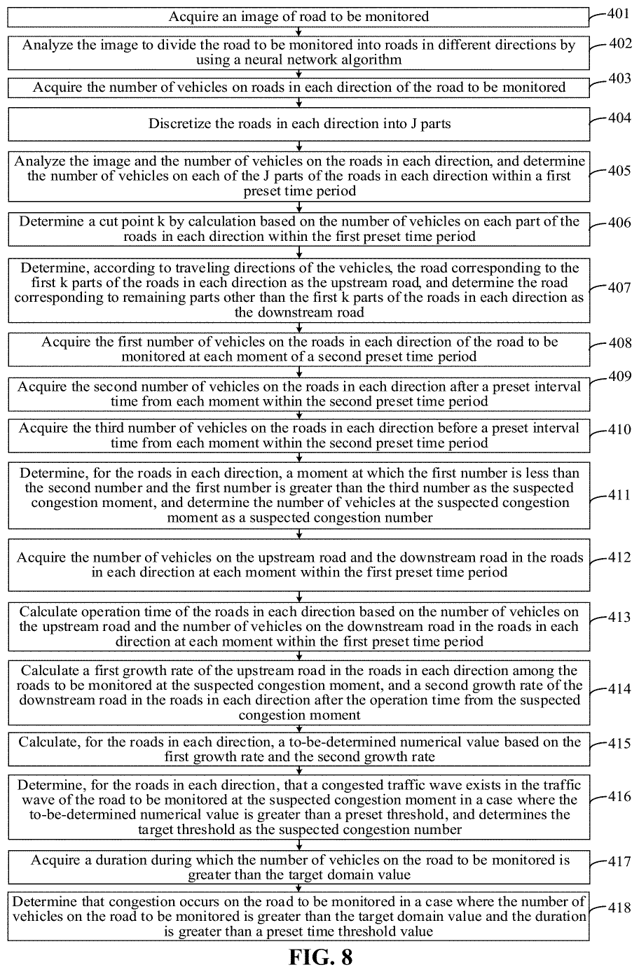

Based on the foregoing embodiments, the embodiments of this application provide a method for determining road operation condition. Referring to FIG. 8, the method includes the following operations.

At operation 401, a device for determining road operation condition acquires an image of a road to be monitored. The image is obtained by photographing the road to be monitored.

At operation 402, the device for determining road operation condition analyzes the image of the road to be monitored by using a neural network algorithm, and divides the road to be monitored into roads in different directions.

At operation 403, the device for determining road operation condition respectively acquires the number of vehicles on roads in each direction of the road to be monitored.

At operation 404, the device for determining road operation condition respectively discretizes the roads in each direction into J parts, where J is a positive integer greater than 1.

At operation 405, the device for determining road operation condition analyzes the image of the road to be monitored and the number of vehicles on the roads in each direction, and respectively determines the number of vehicles on each of the J parts of the roads in each direction within a first preset time period.

At operation 406, the device for determining road operation condition determines a cut point k by calculation based on the number of vehicles on each part of the roads in each direction within the first preset time period.

It is to be noted that the formula

$$k = argmin {\sum }_{t = 0}^{T 1} \vert {\sum }_{j = k + 1}^{J} {x}_{j}^{t} - {\sum }_{j = 1}^{k} {x}_{j}^{t} \vert$$

may be used, where x^{t}ⱼ represents the number of vehicles on each part of the roads in each direction at moment t, and k is an unknown number. In some embodiments of this application, the value of k may be the value of k corresponding to the minimum value of

$${\sum }_{t = 0}^{T 1} \vert {\sum }_{j = k + 1}^{J} {x}_{j}^{t} - {\sum }_{j = 1}^{k} {x}_{j}^{t} \vert .$$

At operation 407, the device for determining road operation condition determines, according to traveling directions of the vehicles, at least one road corresponding to the first k parts of the roads in each direction as the upstream road, and determines at least one road corresponding to those other than the first k parts of the roads in each direction as the downstream road.

In some embodiments of this application, for the roads in each direction, along the traveling directions of the vehicles, the road(s) corresponding to the first k parts may be determined as the upstream road, and the road(s) corresponding to those other than the first k parts may be determined as the downstream road, respectively.

At operation 408, the device for determining road operation condition acquires the first number of vehicles on the roads in each direction of the road to be monitored at each moment within a second preset time period.

At operation 409, the device for determining road operation condition acquires the second number of vehicles on the roads in each direction after a preset interval time from each moment within the second preset time period.

At operation 410, the device for determining road operation condition acquires the third number of vehicles on the roads in each direction before the preset interval time from each moment within the second preset time period.

At operation 411, for the roads in each direction, the device for determining road operation condition determines a moment at which the first number is less than the second number and the first number is greater than the third number as the suspected congestion moment, and determines the number of vehicles at the suspected congestion moment as the suspected congestion number.

At operation 412, the device for determining road operation condition acquires the number of vehicles on the upstream road and the number of vehicles on the downstream road in the roads in each direction at each moment within the first preset time period.

At operation 413, the device for determining road operation condition calculates operation time of the roads in each direction based on the number of vehicles on the upstream road and the number of vehicles on the downstream road in the roads in each direction at each moment within the first preset time period. The operation time is the time when the vehicles travel from the upstream road to the downstream road.

At operation 414, the device for determining road operation condition calculates a first growth rate for the upstream road in the roads in each direction of the road to be monitored at the suspected congestion moment, and a second growth rate for the downstream road in the roads in each direction after the operation time from the suspected congestion moment.

The operation 414 that the device for determining road operation condition calculates a first growth rate for the upstream road in the roads in each direction of the road to be monitored at the suspected congestion moment, and a second growth rate for the downstream road in the roads in each direction after the operation time from the suspected congestion moment can be implemented in the following manner including operations 414a, 414b, 414c, 414d.

At operation 414a, the device for determining road operation condition acquires the number of vehicles on the upstream road in the roads in each direction at the suspected congestion moment, and the number of vehicles on the downstream road in the roads in each direction at a moment after the operation time from the suspected congestion moment.

At operation 414b, the device for determining road operation condition calculates the first average number of vehicles on the upstream road in the roads in each direction and the second average number of vehicles on the downstream road within a third preset time period.

At operation 414b, the device for determining road operation condition calculates the first growth rate based on the number of vehicles on the upstream road in the roads in each direction at the suspected congestion moment and the first average number of vehicles on the roads in each direction.

At operation 414b, the device for determining road operation condition calculates the second growth rate based on the number of vehicles on the downstream road in the roads in each direction at the moment after the operation time from the suspected congestion moment and the second average number of vehicles on the roads in each direction.

In some embodiments of this application, the first growth rate and the second growth rate may be calculated by using formula

$${Δx\_grow}_{i}^{t} = \frac{{x}_{i}^{t} - {\overline{x}}_{i}}{{\overline{x}}_{i}} ,$$

where xᵢ∈[xᵤₚ, x_{down}]; xᵢ^{t} represents the number of vehicles on the upstream road in the roads in each direction at the suspected congestion moment, or the number of vehicles on the downstream road in the roads in each direction at the suspected congestion moment, and X̅ᵢ, represents a first average number of vehicles or a second average number of vehicles; Δx_growᵢ^{t} represents a growth rate of the upstream road or the downstream road. It is to be noted that when calculating the second growth rate, t is replaced with t+Δt.

In the embodiments of this application, the value of each moment is 5 to 10 seconds.

At operation 415, the device for determining road operation condition calculates, for the roads in each direction, a to-be-determined numerical value based on the first growth rate and the second growth rate.

The operation 415 that the device for determining road operation condition calculates, for the roads in each direction, a to-be-determined numerical value based on the first growth rate and the second growth rate can be implemented in the following manner including operations 415a, 415b, 415c.

At operation 415a, the device for determining road operation condition calculates a first difference between the growth rates of the upstream road and the downstream road in the roads in each direction based on the first growth rate and the second growth rate of the roads in each direction.

It is to be noted that, the first difference may be calculated using the formula Δspace_rate^{t}=Δx_grow_{down}^{t+τ}−Δx_growᵤₚ^{t}, where Δspace_rate^{t} represents the first difference, Δx_grow_{down}^{t+τ} represents the second growth rate, and Δx_growᵤₚ^{t} represents the first growth rate.

At operation 415a, the device for determining road operation condition calculates a second difference between the number of vehicles on the roads in each direction at the suspected congestion moment and the number of vehicles on the roads in each direction at the previous moment of the suspected congestion moment.

It is to be noted that, the second difference may be calculated using the formula

$$Δ {time}_{rate}^{t} = {\sum }_{i = 1}^{2} {x}_{i}^{t} - {\sum }_{i = 1}^{2} {x}_{i}^{t - 1} ,$$

where Δtimeᵣₐₜₑ^{t} represents the second difference, and xᵢ^{t-1} represents the number of vehicles at moment t−1.

At operation 415c, the device for determining road operation condition calculates, for the roads in each direction, the to-be-determined numerical value based on the first difference and the second difference.

When calculating the to-be-determined numerical value based on the first difference and the second difference, an identification function may be first generated based on the first difference and the second difference, and then the value of the identification function is calculated to obtain the to-be-determined numerical value. In some embodiments of this application, if the second difference is greater than zero, the identification function may be the product of the first difference and the square of the second difference. If the second difference is less than or equal to zero, the identification function may be the first difference. In some embodiments of this application, the identification function may be represented with f(t);

$$f ( t ) = \{ \begin{matrix}{( Δ {time}_{rate}^{t} )}^{2} \cdot {Δspace\_rate}^{t} \\ {Δspace\_rate}^{t}\end{matrix} ,$$

where if Δtimeᵣₐₜₑ^{t}>0, f(t)=(Δtimeᵣₐₜₑ^{t})². Δspace_rate^{t}; and if Δtimeᵣₐₜₑ^{t}<0 f(t)=Δspace_rate^{t}.

At operation 416, for the roads in each direction, in a case where the value of the to-be-determined numerical value is greater than a preset threshold value, the device for determining road operation condition determines that a congested traffic wave exists in the traffic wave of the road to be monitored at the suspected congestion moment, and determines the target threshold value as the suspected congestion number.

It is to be noted that, the preset threshold value may be αxᵢ^{t}; where α is a coefficient, and the value of α may be [0, 1]; the preset threshold value may be set according to the historical number of vehicles; if f(t)>αxᵢ^{t}, it indicates that there is traffic wave propagation. Δspace_rate^{t}>0 indicates that the growth rate of the downstream is greater than the growth rate of the upstream, and the traffic wave tend to propagate upstream. Δ_timeᵣₐₜₑ^{t}>0 indicates that the number of vehicles at the current moment is greater than the number of vehicles in the past, and the number of vehicles in the area has an increasing trend. The satisfaction of the both indicates that congestion will occur.

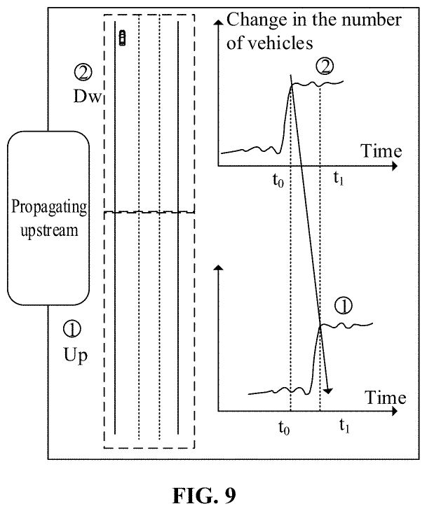

In some embodiments of this application, when congestion occurs on a road, a traffic wave will inevitably occur. According to the theory of traffic waves, as shown in FIG. 9, the traffic wave (aggregation wave) formed by congestion propagates to the upstream road along the tail of the vehicle queue, that is, propagates from the downstream road to the upstream road. Moreover, as shown in FIG. 9, at the beginning of the congestion, the number of vehicles on the downstream road increases sharply, and after the congestion is formed, the number of vehicles on the upstream road increases sharply. That is, the number of vehicles on the downstream road first increases sharply, and then the number of vehicles on the upstream road increases sharply.

In some embodiments of this application, a congestion determination for the road to be monitored may be performed once every 30 seconds.

At operation 417, the device for determining road operation condition acquires a duration during which the number of vehicles on the road to be monitored is greater than the target domain value.

In the embodiments of this application, the duration may be 2 to 5 minutes.

At operation 418, in a case where the number of vehicles on the road to be monitored is greater than the target domain value and the duration is greater than a preset time threshold value, the device for determining road operation condition determines that congestion occurs on the road to be monitored.

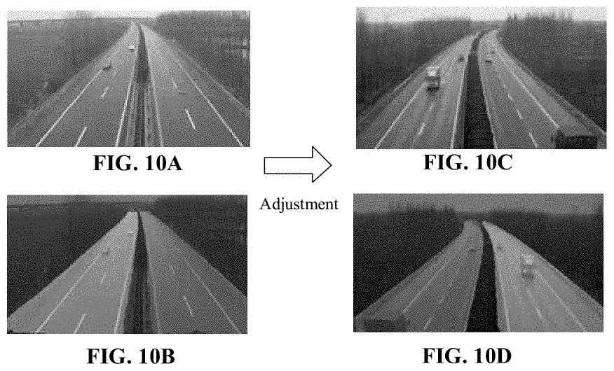

When the operations in the embodiments of this application are executed, whether a camera capturing the images of the road to be monitored rotates is determined before each congestion determination. If the camera rotates, the method for determining road operation condition in this application may be employed to re-determine whether congestion occurs on the road to be monitored. The determining whether the camera rotates may be implemented by using a twin network to compare whether the picture scenes shown in two consecutive frames are the same. FIG. 10A and FIG. 10B show images taken before the camera rotates, and FIG. 10C and FIG. 10D show images taken after the camera rotates.

The first preset time period, the second preset time period, and the third preset time period may be different.

It is to be noted that, for descriptions of operations and contents in this embodiment identical to those in other embodiments, reference may be made to the descriptions in other embodiments.

According to the method for determining road operation condition provided by the embodiments of this application, whether a road to be monitored is congested can be determined directly based on a target threshold value determined according to images of the roads to be monitored and the number of vehicles on the road, without manually setting a monitoring area or determining the speeds of the vehicles. The solutions for determining road congestion in related technologies have the problem of inaccurate determination of road congestion, while this application improves the accuracy of determining road congestion.

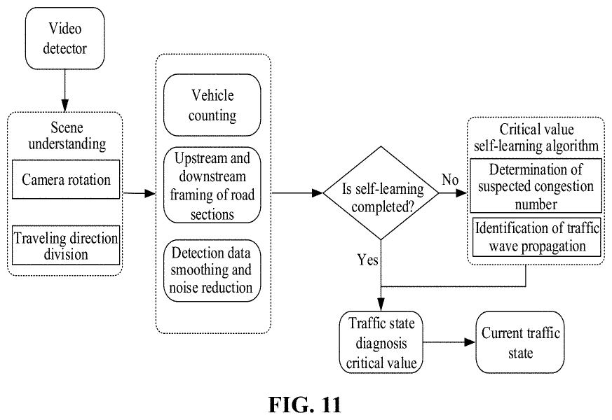

Based on the foregoing embodiments, as shown in FIG. 11, when determining road operation conditions, a video detector may be employed to capture the image of road to be monitored; the road to be monitored is divided according to whether a camera rotates and traveling directions; the number of vehicles on the road to be monitored is counted, up-and-down framing of road sections of the road to be monitored is performed, and detection data smoothing and noise reduction are performed; subsequently, it is determined whether a self-learning algorithm of a target threshold value is completed, and if yes, the target threshold value is directly determined, or if not, the self-learning algorithm of the target threshold value is performed, and then the target threshold value is determined, thereby determining the traffic state of the road to be monitored. The detection data smoothing and noise reduction refers to the limited descriptions of the first preset time period, the second preset time period, the third preset time period, the moment, the congestion duration, the congestion determination time, and the number of frames in an image acquisition interval described in the foregoing embodiments. The learning algorithm of the target threshold may include two parts: suspected congestion number determination and traffic wave propagation identification.

Based on the foregoing embodiments, the embodiments of this application provide an apparatus for determining road operation condition. The apparatus may be applied in the method for determining road operation condition provided by the embodiments corresponding to FIG. 2, FIG. 3, and FIG. 8.

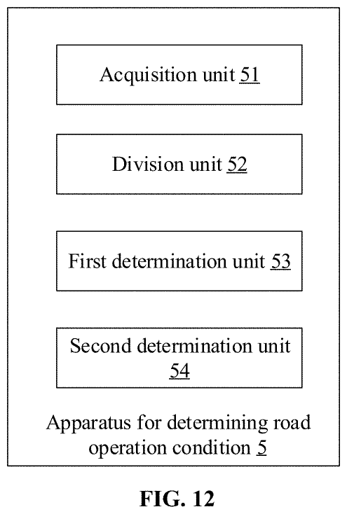

Referring to FIG. 12, the apparatus 5 may include:

an acquisition unit 51, configured to acquire an image of a road to be monitored, where the image is obtained by photographing the road to be monitored;

a division unit 52, configured to acquire the number of vehicles on the road to be monitored, and divide the road to be monitored into an upstream road and a downstream road based on the image of the road to be monitored and the number of vehicles on the road to be monitored;

a first determination unit 53, configured to acquire the number of vehicles on the upstream road and the number of vehicles on the downstream road in the road to be monitored, and determine a target domain value based on the number of vehicles on the road to be monitored, the number of vehicles on the upstream road, the number of vehicles on the downstream road, and a traffic wave of the road to be monitored; and

a second determination unit 54, configured to determine that congestion occurs on the road to be monitored in a case where the number of vehicles on the road to be monitored is greater than the target domain value.

In other embodiments of this application, the division unit 52 may include:

a first determination module, configured to analyze the image of the road to be monitored by using a neural network algorithm to divide the road to be monitored into roads in different directions; and

a first acquisition module, configured to respectively acquire the number of vehicles on roads in each direction of the road to be monitored.

Correspondingly, the division unit 52 further includes: a first division module, configured to respectively divide the roads in each direction into an upstream road and a downstream road based on the image of the road to be monitored and the number of vehicles on the roads in each direction.

In other embodiments of this application, the first division module is further configured to:

respectively discretize the roads in each direction into J parts, where J is a positive integer greater than 1;

analyze the image of the road to be monitored and the number of vehicles on the roads in each direction to respectively determine the number of vehicles on each of the J parts of the roads in each direction within a first preset time period; and

calculate the number of vehicles on each part of the roads in each direction within the first preset time period, and divide the roads in each direction into the upstream road and the downstream road based on a calculation result.

In other embodiments of this application, the first division module is further configured to:

determine a cut point k by calculation based on the number of vehicles on each part of the roads in each direction within the first preset time period; and

determine, according to traveling directions of the vehicles, the at least one road corresponding to the first k parts of the roads in each direction as the upstream road, and determined the at least one road corresponding to those other than the first k parts of the roads in each direction as the downstream road.

In other embodiments of this application, the division unit 52 may further include: a second acquisition module, configured to acquire the first number of vehicles on roads in each direction of the road to be monitored at each moment within a second preset time period.

Correspondingly, the first determination unit 53 includes:

a second determination module, configured to determine a suspected congestion moment and a suspected congestion number for the roads in each direction by calculation based on the first number of vehicles on the roads in each direction of the road to be monitored at each moment within the second preset time period;

a second acquisition module, configured to acquire the number of vehicles on the upstream road and the number of vehicles on the downstream road in the roads in each direction at each moment within a first preset time period; and

a third determination module, configured to, for the roads in each direction, when determining, based on the number of vehicles on the upstream road and the number of vehicles on the downstream road in the roads in each direction at each moment within the first preset time period, that a congested traffic wave exists in the traffic wave of the road to be monitored at the suspected congestion moment, determine the target domain value as the suspected congestion number.

In other embodiments of this application, the second determination module is further configured to:

acquire the second number of vehicles on the roads in each direction after a preset interval time from each moment within the second preset time period;

acquire the third number of vehicles on the roads in each direction before a preset interval time from each moment within the second preset time period; and

for the roads in each direction, determine a moment at which the first number is less than the second number and the first number is greater than the third number as the suspected congestion moment, and determine the number of vehicles at the suspected congestion moment as the suspected congestion number.

In other embodiments of this application, the third determination module is further configured to:

calculate operation time of the roads in each direction based on the number of vehicles on the upstream road and the number of vehicles on the downstream road in the roads in each direction at each moment within the first preset time period, where the operation time is the time when the vehicles travel from the upstream road to the downstream road;

calculate a first growth rate for the upstream road in the roads in each direction of the road to be monitored at the suspected congestion moment, and a second growth rate for the downstream road in the roads in each direction after the operation time from the suspected congestion moment;

for the roads in each direction, calculate a to-be-determined numerical value based on the first growth rate and the second growth rate; and

for the roads in each direction, in a case where the to-be-determined numerical value is greater than a preset threshold value, determine that a congested traffic wave exists in the traffic wave of the road to be monitored at the suspected congestion moment, and determine the target threshold value as the suspected congestion number.

In other embodiments of this application, the third determination module is further configured to:

acquire the number of vehicles on the roads in each direction at the suspected congestion moment, and the number of vehicles at a moment after the operation time from the suspected congestion moment;

calculate the first average number of vehicles on the upstream road in the roads in each direction and the second average number of vehicles on the downstream road within a third preset time period;

calculate the first growth rate based on the number of vehicles on the upstream road in the roads in each direction at the suspected congestion moment and the first average number of vehicles on the roads in each direction; and

calculate the second growth rate based on the number of vehicles on the downstream road in the roads in each direction at the moment after the operation time from the suspected congestion moment and the second average number of vehicles on the roads in each direction.

In other embodiments of this application, the third determination module is further configured to:

calculate a first difference between a growth rate of the upstream road and a growth rate of the downstream road in the roads in each direction based on the first growth rate and the second growth rate of the roads in each direction;

calculate a second difference between the number of vehicles on the roads in each direction at the suspected congestion moment and the number of vehicles on the roads in each direction at the previous moment of the suspected congestion moment; and

for the roads in each direction, calculate the to-be-determined numerical value based on the first difference and the second difference.

In other embodiments of this application, the second determination unit is further configured to:

acquire a duration during which the number of vehicles on the road to be monitored is greater than the target domain value; and

determine that congestion occurs on the road to be monitored in a case where the number of vehicles on the road to be monitored is greater than the target domain value and the duration is greater than a preset time threshold value.

It is to be noted that, for an implementation process of information exchange between the various units and modules in the embodiments of the disclosure, reference may be made to the description in the method for determining road operation condition provided in the embodiments corresponding to FIG. 2, FIG. 3, and FIG. 8.

According to the apparatus for determining road operation condition provided by the embodiments of this application, whether the road to be monitored is congested can be determined directly based on a target threshold value determined according to images of the road to be monitored and the number of vehicles on the road, without manually setting a monitoring area or determining the speeds of the vehicles. The solutions for determining road congestion in related technologies have the problem of inaccurate judgment of road congestion, while this application improves the accuracy of determining road congestion.

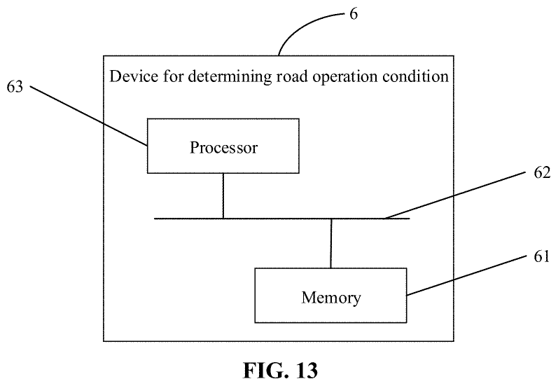

The embodiments of this application provide a device for determining road operation condition. The device may be applied in the method for determining road operation condition provided by the embodiments corresponding to FIG. 2, FIG. 3, and FIG. 8. Referring to FIG. 13, the device 6 may include at least a memory 61, a communication bus 62, and a processor 63.

The memory 61 is configured to store a road operation condition determination program.

The communication bus 62 is configured to implement connection communication between the processor 63 and the memory 61.

The processor 63 is configured to execute the road operation condition determination program stored in the memory 61 to implement the following operations:

acquiring an image of a road to be monitored, where the image is obtained by photographing the road to be monitored;

acquiring the number of vehicles on the road to be monitored, and dividing the road to be monitored into an upstream road and a downstream road based on the image of the road to be monitored and the number of vehicles on the road to be monitored;

acquiring the number of vehicles on the upstream road and the number of vehicles on the downstream road in the road to be monitored, and determining a target domain value based on the number of vehicles on the road to be monitored, the number of vehicles on the upstream road, the number of vehicles on the downstream road, and a traffic wave of the road to be monitored; and

in a case where the number of vehicles on the road to be monitored is greater than the target domain value, determining that congestion occurs on the road to be monitored.

In other embodiments of this application, the processor 63 is configured to execute the dividing the road to be monitored into an upstream road and a downstream road based on the image of the road to be monitored in the road operation condition determination program stored in the memory 61, so as to implement the following operations:

analyzing the image of the road to be monitored by using a neural network algorithm to respectively divide roads in each direction into the upstream road and the downstream road;

respectively acquiring the number of vehicles on roads in each direction of the road to be monitored; and

respectively dividing the roads in each direction into the upstream road and the downstream road based on the image of the road to be monitored and the number of vehicles on the roads in each direction.

In other embodiments of this application, the processor 63 is configured to execute the respectively dividing the roads in each direction into the upstream road and the downstream road based on the image of the road to be monitored and the number of vehicles on the roads in each direction in the road operation condition determination program stored in the memory 61, so as to implement the following operations:

respectively discretizing the roads in each direction into J parts, where J is a positive integer greater than 1;

analyzing the image of the road to be monitored and the number of vehicles on the roads in each direction to respectively determine the number of vehicles on each of the J parts of the roads in each direction within a first preset time period; and

performing calculation processing on the number of vehicles on each part of the roads in each direction within the first preset time period, and dividing the roads in each direction into the upstream road and the downstream road based on a calculation result.

In other embodiments of this application, the processor 63 is configured to execute the calculating the number of vehicles on each part of the roads in each direction within the first preset time period, and dividing the roads in each direction into the upstream road and the downstream road based on a calculation result in the road operation condition determination program stored in the memory 61, so as to implement the following operations:

determining a cut point k by calculation based on the number of vehicles on each part of the roads in each direction within the first preset time period; and

determining, according to traveling directions of the vehicles, at least one road corresponding to the first k parts of the roads in each direction as the upstream road, and at least one road corresponding to those other than the first k parts of the roads in each direction as the downstream road.

In other embodiments of this application, the processor 63 is configured to execute the acquiring the number of vehicles on the road to be monitored, the number of vehicles on the upstream road and the number of vehicles on the downstream road, and determining a target domain value based on the number of vehicles on the road to be monitored, the number of vehicles on the upstream road, the number of vehicles on the downstream road, and a traffic wave of the road to be monitored in the road operation condition determination program stored in the memory 61, so as to implement the following operations:

acquiring the first number of vehicles on roads in each direction of the road to be monitored at each moment within a second preset time period; and

determining a suspected congestion moment and a suspected congestion number for the roads in each direction by calculation based on the first number of vehicles on the roads in each direction of the road to be monitored at each moment within the second preset time period;

acquiring the number of vehicles on the upstream road and the number of vehicles on the downstream road in the roads in each direction at each moment within a first preset time period; and

for the roads in each direction, when determining, based on the number of vehicles on the upstream road and the number of vehicles on the downstream road in the roads in each direction at each moment within the first preset time period, that a congested traffic wave exists in the traffic wave of the road to be monitored at the suspected congestion moment, determining the target domain value as the suspected congestion number.

In other embodiments of this application, the processor 63 is configured to execute the determining a suspected congestion moment and a suspected congestion number for the roads in each direction by calculation based on the first number of vehicles on the roads in each direction of the road to be monitored at each moment within the second preset time period in the road operation condition determination program stored in the memory 61, so as to implement the following operations:

acquiring the second number of vehicles on the roads in each direction after a preset interval time from each moment within the second preset time period;

acquiring the third number of vehicles on the roads in each direction before a preset interval time from each moment within the second preset time period; and

for the roads in each direction, determining a moment at which the first number is less than the second number and the first number is greater than the third number as the suspected congestion moment, and determining the number of vehicles at the suspected congestion moment as the suspected congestion number.

In other embodiments of this application, the processor 63 is configured to execute the operation of for the roads in each direction, determining a moment at which the first number is less than the second number and the first number is greater than the third number as the suspected congestion moment, and determining the number of vehicles at the suspected congestion moment as the suspected congestion number in the road operation condition determination program stored in the memory 61, so as to implement the following operations:

calculating operation time of the roads in each direction based on the number of vehicles on the upstream road and the number of vehicles on the downstream road in the roads in each direction at each moment within the first preset time period, where the operation time is the time when the vehicles travel from the upstream road to the downstream road;

calculating a first growth rate for the upstream road in the roads in each direction of the road to be monitored at the suspected congestion moment, and a second growth rate for the downstream road in the roads in each direction after the operation time from the suspected congestion moment;

for the roads in each direction, calculating a to-be-determined numerical value based on the first growth rate and the second growth rate; and

for the roads in each direction, in a case where the to-be-determined numerical value is greater than a preset threshold value, determining that a congested traffic wave exists in the traffic wave of the road to be monitored at the suspected congestion moment, and determining the target threshold value as the suspected congestion number.

In other embodiments of this application, the processor 63 is configured to execute the calculating a first growth rate for the upstream road in the roads in each direction of the road to be monitored at the suspected congestion moment, and a second growth rate for the downstream road in the roads in each direction after the operation time from the suspected congestion moment in the road operation condition determination program stored in the memory 61, so as to implement the following to-be-determined:

acquiring the number of vehicles on the roads in each direction at the suspected congestion moment, and the number of vehicles at a moment after the operation time from the suspected congestion moment;

calculating the first average number of vehicles on the upstream road in the roads in each direction and the second average number of vehicles on the downstream road within a third preset time period;

calculating the first growth rate based on the number of vehicles on the upstream road in the roads in each direction at the suspected congestion moment and the first average number of vehicles on the roads in each direction; and

calculating the second growth rate based on the number of vehicles on the downstream road in the roads in each direction at the moment after the operation time from the suspected congestion moment and the second average number of vehicles on the roads in each direction.

In other embodiments of this application, the processor 63 is configured to execute the operation of for the roads in each direction, calculating a to-be-determined numerical value based on the first growth rate and the second growth rate in the road operation condition determination program stored in the memory 61, so as to implement the following operations:

calculating a first difference between a growth rate of the upstream road and a growth rate of the downstream road in the roads in each direction based on the first growth rate and the second growth rate of the roads in each direction;

calculating a second difference between the number of vehicles on the roads in each direction at the suspected congestion moment and the number of vehicles on the roads in each direction at the previous moment of the suspected congestion moment; and

for the roads in each direction, calculating the to-be-determined numerical value based on the first difference and the second difference.

In other embodiments of this application, the processor 63 is configured to execute the operation of determining that congestion occurs on the road to be monitored in a case where the number of vehicles on the road to be monitored is greater than the target domain value in the road operation condition determination program stored in the memory 61, so as to implement the following operations:

acquiring a duration during which the number of vehicles on the road to be monitored is greater than the target domain value; and

determining that congestion occurs on the road to be monitored in a case where the number of vehicles on the road to be monitored is greater than the target domain value and the duration is greater than a preset time threshold value.

It is to be noted that, for a specific implementation process of the operations executed by the processor in this embodiment, reference may be made to the implementation process in the method for determining road operation condition provided in the embodiments corresponding to FIG. 2, FIG. 3, and FIG. 8.

According to the device for determining road operation condition provided by the embodiments of this application, whether roads to be monitored is congested can be determined directly based on a target threshold value determined according to images of the roads to be monitored and the number of vehicles on the road, without manually setting a monitoring area or determining the speeds of the vehicles. The solutions for determining road congestion in related technologies have the problem of inaccurate judgment of road congestion, while this application improves the accuracy of determining road congestion.

Based on the foregoing embodiments, the embodiments of this application provide a computer-readable storage medium. The computer-readable storage medium has one or more computer programs stored thereon. The one or more computer programs, may be executed by one or more processors to implement the operations of the road method for determining operation condition provided in the embodiments corresponding to FIG. 2, FIG. 3, and FIG. 8.

Based on the foregoing embodiments, the embodiments of this application provide a computer program, including a computer-readable code. When the computer-readable code runs in a device for determining road operation condition, a processor in the device for determining road operation condition executes the computer program to implement the operations of the method for determining road operation condition provided in the embodiments corresponding to FIG. 2, FIG. 3, and FIG. 8.

In the several embodiments provided in this application, it is to be understood that the disclosed method and apparatus may be implemented in other manners. For example, the apparatus embodiments described above are only schematic, and for example, division of the modules or units is only logic function division, and other division manners may be adopted during practical implementation. For example, units or components may be combined or integrated into another system, or some features may be neglected or not executed. In addition, coupling or direct coupling or communication connection between the displayed or discussed components may be indirect coupling or communication connection, implemented through some interfaces, means or units, and may be electrical and mechanical form or adopt other forms.

The units described as separate components may or may not be physically separated, and the components displayed as units may or may not be physical units, and may be located in one place or may be distributed over network units. Some or all of the units may be selected based on actual needs to achieve the objectives of the solutions of the embodiments in the present application.

In addition, functional units in the embodiments of this application may be integrated into one processing unit, or each of the units may be physically separated, or two or more units may be integrated into one unit. The integrated unit may be implemented in the form of hardware, or in a form of software functional units.

When the integrated units are implemented in a form of software functional units and sold or used as an independent product, the integrated units may be stored in a computer-readable storage medium. Based on such an understanding, the technical solutions of this application essentially, or a part contributing to the related art, or all or a part of the technical solution may be implemented in a form of a software product. The computer software product is stored in a storage medium and includes several instructions for instructing a computer device (which may be a personal computer, a server, a network device or the like) or a processor to perform all or some of the steps of the method in each embodiment of this application. The above-mentioned storage medium includes: various media capable of storing program codes such as a U disk, a mobile hard disk, a Read-Only Memory (ROM), a Random-Access Memory (RAM), a magnetic disk or an optical disk.

The embodiments of this application disclose a method and an apparatus for determining road operation condition, a device, and a storage medium. The method includes: acquiring an image of a road to be monitored, where the image is obtained by photographing the road to be monitored; acquiring the number of vehicles on the road to be monitored, and dividing the road to be monitored into an upstream road and a downstream road based on the image of the road to be monitored and the number of vehicles on the road to be monitored; acquiring the number of vehicles on the upstream road and the number of vehicles on the downstream road, and determining a target domain value based on the number of vehicles on the road to be monitored, the number of vehicles on the upstream road, the number of vehicles on the downstream road, and a traffic wave of the road to be monitored; and determining that congestion occurs on the road to be monitored in a case where the number of vehicles on the road to be monitored is greater than the target domain value. Detection of target based on this model can improve the accuracy of target detection. The, whether congestion occurs on the roads to be monitored can be determined directly based on the target threshold value determined according to the images of the roads to be monitored and the number of vehicles on the road, thereby improving the accuracy of determining road congestion.

What is claimed is:

1. A method for determining road operation condition, comprising:
acquiring an image of a road to be monitored, wherein the image is obtained by photographing the road to be monitored;
acquiring a number of vehicles on the road to be monitored, and dividing the road to be monitored into an upstream road and a downstream road based on the image and the number of vehicles on the road to be monitored;
acquiring a number of vehicles on the upstream road and a number of vehicles on the downstream road, and determining a target domain value based on the number of vehicles on the road to be monitored, the number of vehicles on the upstream road, the number of vehicles on the downstream road, and a traffic wave of the road to be monitored; and
determining that congestion occurs on the road to be monitored in a case where the number of vehicles on the road to be monitored is greater than the target domain value.

2. The method of claim 1, wherein the acquiring the number of vehicles on the road to be monitored comprises:
analyzing the image of the road to be monitored by using a neural network algorithm to divide the road to be monitored into roads in different directions; and
respectively acquiring a number of vehicles on roads in each direction of the road to be monitored; and
correspondingly, the step of dividing the road to be monitored into an upstream road and a downstream road based on the image of the road to be monitored and the number of vehicles on the road to be monitored comprises:
respectively dividing the roads in each direction into an upstream road and a downstream road based on the image of the road to be monitored and the number of vehicles on the roads in each direction.

3. The method of claim 2, wherein the respectively dividing the roads in each direction into an upstream road and a downstream road based on the image of the road to be monitored and the number of vehicles on the roads in each direction comprises:
respectively discretizing the roads in each direction into J parts, wherein J is a positive integer greater than 1;
analyzing the image of the road to be monitored and the number of vehicles on the roads in each direction to respectively determine a number of vehicles on each of the J parts of the roads in each direction within a first preset time period; and
performing calculation processing on the number of vehicles on each part of the roads in each direction within the first preset time period, and dividing the roads in each direction into the upstream road and the downstream road based on a calculation result.

4. The method of claim 3, wherein the performing calculation processing on the number of vehicles on each part of the roads in each direction within the first preset time period, and dividing the roads in each direction into the upstream road and the downstream road based on a calculation result comprises:
determining a cut point k by calculation based on the number of vehicles on each part of the roads in each direction within the first preset time period; and
determining, according to traveling directions of the vehicles, one or more roads corresponding to first k parts of the roads in each direction as the upstream road, and determining one or more roads corresponding to a remaining part other than the first k parts of the roads in each direction as the downstream road.

5. The method of claim 1, wherein the acquiring the number of vehicles on the road to be monitored comprises:
acquiring a first number of vehicles on roads in each direction of the road to be monitored at each moment within a second preset time period; and
correspondingly, the step of acquiring the number of vehicles on the upstream road and the number of vehicles on the downstream road, and determining a target domain value based on the number of vehicles on the road to be monitored, the number of vehicles on the upstream road, the number of vehicles on the downstream road, and a traffic wave of the road to be monitored comprises:
determining a suspected congestion moment and a suspected congestion number for the roads in each direction by calculation based on the first number of vehicles on the roads in each direction of the road to be monitored at each moment within the second preset time period;
acquiring the number of vehicles on the upstream road and the number of vehicles on the downstream road in the roads in each direction at each moment within a first preset time period; and
for the roads in each direction, responsive to determining, based on the number of vehicles on the upstream road and the number of vehicles on the downstream road in the roads in each direction at each moment within the first preset time period, that a congested traffic wave exists in the traffic wave of the road to be monitored at the suspected congestion moment, determining the target domain value as the suspected congestion number.

6. The method of claim 5, wherein the determining a suspected congestion moment and a suspected congestion number for the roads in each direction by calculation based on the first number of vehicles on the roads in each direction of the road to be monitored at each moment within the second preset time period comprises:
acquiring a second number of vehicles on the roads in each direction after a preset interval time from each moment within the second preset time period;
acquiring a third number of vehicles on the roads in each direction before a preset interval time from each moment within the second preset time period; and
for the roads in each direction, determining a moment at which the first number is less than the second number and the first number is greater than the third number as the suspected congestion moment, and determining a number of vehicles at the suspected congestion moment as the suspected congestion number.

7. The method of claim 5, wherein said for the roads in each direction, responsive to determining, based on the number of vehicles on the upstream road and the number of vehicles on the downstream road in the roads in each direction at each moment within the first preset time period, that a congested traffic wave exists in the traffic wave of the road to be monitored at the suspected congestion moment, determining the target domain value as the suspected congestion number comprises:
calculating operation time of the roads in each direction based on the number of vehicles on the upstream road and the number of vehicles on the downstream road in the roads in each direction at each moment within the first preset time period, wherein the operation time is time when the vehicles travel from the upstream road to the downstream road;
calculating a first growth rate for the upstream road in the roads in each direction of the road to be monitored at the suspected congestion moment, and a second growth rate for the downstream road in the roads in each direction after the operation time from the suspected congestion moment;
for the roads in each direction, calculating a to-be-determined numerical value based on the first growth rate and the second growth rate; and
for the roads in each direction, in a case where the to-be-determined numerical value is greater than a preset threshold value, determining that a congested traffic wave exists in the traffic wave of the road to be monitored at the suspected congestion moment, and determine the target threshold value as the suspected congestion number.

8. The method of claim 7, wherein the calculating a first growth rate for the upstream road in the roads in each direction of the road to be monitored at the suspected congestion moment, and a second growth rate for the downstream road in the roads in each direction after the operation time from the suspected congestion moment comprises:
acquiring a number of vehicles on the upstream road in the roads in each direction at the suspected congestion moment, and a number of vehicles on the downstream road in the roads in each direction at a moment after the operation time from the suspected congestion moment;
calculating a first average number of vehicles on the upstream road in the roads in each direction and a second average number of vehicles on the downstream road within a third preset time period;
calculating the first growth rate based on the number of vehicles on the upstream road in the roads in each direction at the suspected congestion moment and the first average number of vehicles on the roads in each direction; and
calculating the second growth rate based on the number of vehicles on the downstream road in the roads in each direction at the moment after the operation time from the suspected congestion moment and the second average number of vehicles on the roads in each direction.

9. The method of claim 7, wherein said for the roads in each direction, calculating a to-be-determined numerical value based on the first growth rate and the second growth rate comprises:
calculating a first difference between a growth rate of the upstream road and a growth rate of the downstream road in the roads in each direction based on the first growth rate and the second growth rate of the roads in each direction;
calculating a second difference between the number of vehicles on the roads in each direction at the suspected congestion moment and a number of vehicles on the roads in each direction at a previous moment of the suspected congestion moment; and
for the roads in each direction, calculating the to-be-determined numerical value based on the first difference and the second difference.

10. The method of claim 1, wherein said in a case where the number of vehicles on the road to be monitored is greater than the target domain value, determining that congestion occurs on the road to be monitored comprises:
acquiring a duration during which the number of vehicles on the road to be monitored is greater than the target domain value; and
in a case where the number of vehicles on the road to be monitored is greater than the target domain value and the duration is greater than a preset time threshold value, determining that congestion occurs on the road to be monitored.

11. A device for determining road operation condition, comprising a memory, a communication bus, and a processor, wherein
the memory is configured to store a program for determining road operation condition executable by the processor;
the communication bus is configured to implement connection communication between the processor and the memory; and
the processor is configured to:
acquire an image of road to be monitored, wherein the image is obtained by photographing the road to be monitored;
acquire a number of vehicles on the road to be monitored, and divide the road to be monitored into an upstream road and a downstream road based on the image and the number of vehicles on the road to be monitored;
acquire a number of vehicles on the upstream road and a number of vehicles on the downstream road, and determine a target domain value based on the number of vehicles on the road to be monitored, the number of vehicles on the upstream road, the number of vehicles on the downstream road, and a traffic wave of the road to be monitored; and
determine that congestion occurs on the road to be monitored in a case where the number of vehicles on the road to be monitored is greater than the target domain value.

12. The device of claim 11, wherein the processor is further configured to:
analyze the image by using a neural network algorithm to divide the road to be monitored into roads in different directions; and
respectively acquire a number of vehicles on roads in each direction of the road to be monitored; and
correspondingly, the processor is further configured to:
respectively divide the roads in each direction into an upstream road and a downstream road based on the image of the road to be monitored and the number of vehicles on the roads in each direction.

13. The device of claim 12, wherein the processor is further configured to:
respectively discretize the roads in each direction into J parts, wherein J is a positive integer greater than 1;
analyze the image of the road to be monitored and the number of vehicles on the roads in each direction to respectively determine a number of vehicles on each of the J parts of the roads in each direction within a first preset time period; and
perform calculation processing on the number of vehicles on each part of the roads among the roads in each direction within the first preset time period, and divide the roads in each direction into the upstream road and the downstream road based on a calculation result.

14. The device of claim 13, wherein the processor is further configured to:
determine a cut point k by calculation based on the number of vehicles on each part of the roads in each direction within the first preset time period; and
determine, according to traveling directions of the vehicles, one or more roads corresponding to first k parts of the roads in each direction as the upstream road, and determine none or more roads corresponding to a remaining part other than the first k parts of the roads in each direction as the downstream road.

15. The device of claim 11, wherein the processor is further configured to:
acquire a first number of vehicles on roads in each direction of the road to be monitored at each moment within a second preset time period; and
determine a suspected congestion moment and a suspected congestion number for the roads in each direction by calculation based on the first number of vehicles on the roads in each direction of the road to be monitored at each moment within the second preset time period;
acquire the number of vehicles on the upstream road and the number of vehicles on the downstream road in the roads in each direction at each moment within a first preset time period; and
for the roads in each direction, responsive to determining, based on the number of vehicles on the upstream road and the number of vehicles on the downstream road in the roads in each direction at each moment within the first preset time period, that a congested traffic wave exists in the traffic wave of the road to be monitored at the suspected congestion moment, to determine the target domain value as the suspected congestion number.

16. The device of claim 15, wherein the processor is further configured to:
acquire a second number of vehicles on the roads in each direction after a preset interval time from each moment within the second preset time period;
acquire a third number of vehicles on the roads in each direction before a preset interval time from each moment within the second preset time period; and
for the roads in each direction, determine a moment at which the first number is less than the second number and the first number is greater than the third number as the suspected congestion moment, and determine a number of vehicles at the suspected congestion moment as the suspected congestion number.

17. The device of claim 15, wherein the processor is further configured to:
calculate operation time of the roads in each direction based on the number of vehicles on the upstream road and the number of vehicles on the downstream road in the roads in each direction at each moment within the first preset time period, wherein the operation time is time when the vehicles travel from the upstream road to the downstream road;
calculate a first growth rate for the upstream road in the roads in each direction of the road to be monitored at the suspected congestion moment, and a second growth rate for the downstream road in the roads in each direction after the operation time from the suspected congestion moment;
for the roads in each direction, calculate a to-be-determined numerical value based on the first growth rate and the second growth rate; and
for the roads in each direction, in a case where the to-be-determined numerical value is greater than a preset threshold value, determine that a congested traffic wave exists in the traffic wave of the road to be monitored at the suspected congestion moment, and determine the target threshold value as the suspected congestion number.

18. The device of claim 17, wherein the processor is further configured to:
acquire a number of vehicles on the upstream road in the roads in each direction at the suspected congestion moment, and a number of vehicles on the downstream road in the roads in each direction at a moment after the operation time from the suspected congestion moment;
calculate a first average number of vehicles on the upstream road in the roads in each direction and a second average number of vehicles on the downstream road within a third preset time period;
calculate the first growth rate based on the number of vehicles on the upstream road in the roads in each direction at the suspected congestion moment and the first average number of vehicles on the roads in each direction; and
calculate the second growth rate based on the number of vehicles on the downstream road in the roads in each direction at the moment after the operation time from the suspected congestion moment and the second average number of vehicles on the roads in each direction.

19. The device of claim 17, wherein the processor is further configured to:
calculate a first difference between a growth rate of the upstream road and a growth rate of the downstream road in the roads in each direction based on the first growth rate and the second growth rate of the roads in each direction;
calculate a second difference between the number of vehicles on the roads in each direction at the suspected congestion moment and the number of vehicles on the roads in each direction at a previous moment of the suspected congestion moment; and
for the roads in each direction, calculate the to-be-determined numerical value based on the first difference and the second difference.

20. A non-transitory computer-readable storage medium, having a computer program stored thereon, wherein the computer program, when executed by a processor, implements operations including:
acquiring an image of a road to be monitored, wherein the image is obtained by photographing the road to be monitored;
acquiring a number of vehicles on the road to be monitored, and dividing the road to be monitored into an upstream road and a downstream road based on the image and the number of vehicles on the road to be monitored;
acquiring a number of vehicles on the upstream road and a number of vehicles on the downstream road, and determining a target domain value based on the number of vehicles on the road to be monitored, the number of vehicles on the upstream road, the number of vehicles on the downstream road, and a traffic wave of the road to be monitored; and
determining that congestion occurs on the road to be monitored in a case where the number of vehicles on the road to be monitored is greater than the target domain value.
